(19) United States
(12) Patent Application Publication
(10) Pub. No.: US 2013/0283231 A1
(43) Pub. Date: Oct. 24, 2013

(54) Method and System for Compiling a Unique Sample Code for an Existing Digital Sample

(71) Applicant: Oedses Klaas Van Megchelen, Ede (NL)

(72) Inventor: Oedses Klaas Van Megchelen, Ede (NL)

(73) Assignee: VAN MEGCHELEN & TILANUS B.V., Ede (NL)

(21) Appl. No.: 13/989,615

(22) PCT Filed: Nov. 24, 2010
(86) PCT No.: PCT/NL2010/050788

§ 371 Date: Jul. 12, 2013

(51) Int. Cl. G06F 9/45

(52) U.S. Cl. CPC G06F 8/41
USPC 717/106

(57) ABSTRACT

Method for providing a digital sample with a unique sample code. Computer-readable media with computer-executable instructions and compiled sample codes for accessing digital samples, including physical embodiment of codes such as bar codes or other visually perceptible, radio frequency identification (RFID) codes. System for compiling a unique sample code.

The invention relates to a method for compiling a world-wide unique sample code for an existing digital sample. The invention also relates to a method for providing a digital sample with such a unique sample code. The invention moreover relates to a computer-readable medium with computer-executable instructions which, when loaded onto a computer system, provide the computer system with the functionality of any of the aforementioned methods. The invention additionally relates to a sample code as compiled by the above method. The invention besides relates to a system for compiling a unique sample code for an existing digital sample using the above method.

‘Globalization’ is commonly used as a shorthand way of describing the spread and connectedness of production, communication and technologies across the world. That spread has involved the interlacing of economic and cultural activity. This globalization in the sense of connectivity in economic and cultural life across the world has been growing for centuries. However, many believe the current situation is of a fundamentally different order to what has gone before. The speed of communication and exchange, the complexity and size of the networks involved, and the sheer volume of trade, transaction, interaction and risk give what we now label as ‘globalization’ a peculiar force. One has described globalization as the intensification of world-wide social relations which link distant localities in such a way that local happenings are shaped by events occurring many miles away and vice versa. This involves a change in the way we understand geography and experience localness. As well as offering opportunity it brings with considerable risks linked, for example, to marketing, technological change, climate change and business control.

Globalization, thus, has powerful economic, political, cultural and social dimensions. Developments in the life sciences, and in digital technology and the like, have opened up vast, new possibilities for production, reach and exchange. Innovations like the Internet have made it possible to access information and resources across the world—and to coordinate activities in real time. An important downside of the globalization however is the creation of diffuse markets in which it is becoming harder and harder to control product marketing and demand and supply chain/network processes leading to a considerable increase of the uncontrollable number of illegal copies available using peer-to-peer (P2P) technologies. End-user piracy, which is different from commercial piracy, is much more difficult to control. An auxiliary drawback of these P2P technologies is that Internet traffic has grown enormously. Projections indicate that the Internet traffic will greatly increase, leading to pressure on data traffic and storage and resulting in an increased bandwidth demand on the world's Internet networks. Moreover, this Internet traffic and storage increase will require improved hardware, software and data facilities regardless of their context. Present electrical energy consumption of the Internet is already substantial and is expected to increase significantly in the coming years.

The non-prepublished international patent application PCT/NL2010/050303 discloses a method and system facilitating tracking and tracing legitimate digital products to protect owners and other parties involved in the product demand and supply chain against infringement of intellectual property rights and to protect the both owners and customer against fraudulent distribution by sharing of digital products. To this end, this international patent application discloses a method for compiling a unique sample code for a digital sample, comprising: i) defining at least one sample code template comprising multiple sample code segments to be used for building a sample code for a digital sample, said sample code segments at least comprising: a sample owner identifying code segment, and a sample identifying code segment; ii) specifying the content of the sample code segments to be used for building said sample code, wherein the sample owner identifying code segment is specified by an Internet address, in particular an IP address or (a part of) a domain name, of an owner of the digital sample, iii) stringing the specified sample code segments to form the sample code, iv) defining a digital path to a digital location via which access can be gained to the digital sample, and v) creating a cross-reference between the sample code generated during step iii) and the digital path defined during step iv) in case the sample code and the digital path are mutually distinctive. By labelling each world-wide unique digital sample with a world-wide unique sample code acting as world-wide unique identifier, comparable with a DNA profile or fingerprint of the sample, one specific digital sample can be traced and distinguished easily and unambiguously from another digital sample, and thus each digital sample can be identified throughout over the world regardless of its context. This world-wide unique identification will be facilitated by the recognizable (identifiable) incorporation of the IP address and/or the domain name of a (present or prior) owner of the digital sample. Moreover, since the digital sample code is associated with a digital path to a digital location where the digital sample, and eventual further information (metadata) relating to said digital sample, is stored and can be traced/found, it can be verified relatively easily whether the digital sample has been manipulated or is authentic. This will considerably facilitate assessment of the authenticity of the digital sample and will hence facilitate tracking and tracing of the digital sample. Commonly, the digital sample will not be moved once stored at the digital location. In case the digital sample would still be moved to another digital or physical location, the cross-reference between the sample code and the digital path will be correspondingly updated, so the sample code will be permanently up to date and give permanent access to the digital sample. Hence, dead links due to changes of the digital paths to digital locations where digital samples are stored can be eliminated in this manner.

An object of the invention is to improve the implementation of the aforementioned method for compiling a unique sample code for a digital sample in an existing network environment.

To this end an embodiment of the invention relates to a method for compiling a unique sample code for a digital sample, comprising: A) defining at least one sample code template comprising multiple sample code segments to be used for building a sample code for a digital sample, said sample code segments at least comprising: a sample owner identifying code segment, a sample identifying code segment, and at least one keyword comprising code segment; B) specifying at least one search criterion for sample searching a digital network, C) finding a digital path to a storage location of at least one digital sample in said digital network fulfilling said at least one search criterion, D) specifying the content of the sample code segments to be used for building at least one sample code, wherein the sample owner identifying code segment is specified by an Internet address, in particular an IP address and/or a domain name, of an owner of the digital sample, E) stringing the specified sample code segments to form the sample code, and F) creating a cross-reference between the sample code generated during step E) and the digital path found during step C) in case the sample code and the digital path are mutually distinctive. By searching or crawling an existing network environment, such as an Internet environment or Intranet environment, for digital samples fulfilling one or more predefined search criteria and by specifying the code segments, or at least the at least one keyword comprising code segment, based upon the search results obtained, existing digital samples, in particular existing files, can be coded with a worldwide unique sample code in a relatively efficient manner. In this manner large numbers of digital samples can be codes simultaneously in an easy and quick manner after having defined a sample code template and one or more search criteria. Human interference can be kept to a minimum which is in favour to the user-friendliness of the method according to the invention. The digital sample may comprise an item such as a book, contract, music file, video file, web page, web content, an Internet index file, or any other digital item. After compiling the sample code and connecting the sample code to the digital sample, commonly by tagging the digital sample, the digital sample can be identified and accessed using said unique sample code that is compiled in accordance with embodiments of the invention. Thus, the code and use of the code in various embodiments described herein can be of help, for example, when one wants to correctly identify or share such a digital sample (such as document or file or other digital sample). The code may also help to trace and assure authenticity of the digital sample, to restrict or provide access to the digital sample, to distribute the digital sample to selected recipients, to sell or otherwise monetize the digital sample or to otherwise help provide distribution of or access to the digital sample. As an example, a unique sample code may be provided for a music file. A user is provided access to the music file, and the music file is identified, based on the sample code. Further, the sample code may be embedded into the music file to facilitate tracking and tracing of the music file.

A digital sample, also considered as a single individual digital entity, is thus defined to have a unique identity and to be distinguishable (individualizable) and hence trackable and traceable with certainty from all other digital samples in the scope of its specification criteria. A digital sample as an individual entity therefore differs from a digital product series, a digital product category, or a digital product variety. In the context of the patent application the nature and representation of the term “digital sample” should be interpreted broadly and could include a digital file, a digital textual description, a digital image, a digital collection of multiple digital samples, a digital transaction, or a digital service. The term “owner” incorporates (among others) the originator, publisher, distributor, author, and creator provided that an actual or previous ownership of the digital sample can be deduced from the IP address and/or the domain name of the owner as used and visualized in the sample code itself. The term “digital location” can be a location at a computer of the owner as code issuing party, though it can also be a remote location in a private or public cloud computing infrastructure employing Internet-based computing, whereby shared resources, software and information are provided to computers and other devices on-demand, like a public utility. The sample codes may be stored in a computing cloud, while the digital samples are stored in a location separate from the computing cloud, which would reduce the traffic load within the cloud and would also be beneficial for security reasons. The term “keyword” in the keyword comprising code segment relates to a keyword relating to the digital sample (to be) coded, and is interpreted broadly. The keyword does not necessarily have to be alphabetical though may also be e.g. in numerical or alphanumerical format. As already indicated an object of coding digital samples by such a unique sample code is that a user will commonly directly recognize the content of the code segments which provides the user information (metadata) about the specific digital sample.

Each unique digital file is marked with a world-wide unique sample code. This sample code may represent a file name of the digital sample and/or may be embedded in the digital sample. Sharing the digital sample may be realised by simply sharing the sample code as such, which will provide a lead to the location where the digital sample is stored. Since simply sharing the sample code (approximately 1 kilobyte, for example) will be sufficient to allow authorized sharing of the digital sample (commonly significantly larger than 1 kilobyte), exchanging the digital sample as such is no longer necessary, which can help lead to a significant reduction of the Internet traffic and moreover the (multiple) data storage lead which is advantageous from a financial, safety-related and environmental point of view. The sample owner identifying code segment is commonly (pre)specified by the owner, whereas the sample identifying code segment may be specified by a creator or user of the digital sample.

It is conceivable that step D) is at least partially executed prior to step C), wherein at least one sample code segment is specified prior to finding the digital path to at least one digital sample. More particularly, in an embodiment of the method according to the invention at least one keyword comprising code segment is specified according to step D) prior to finding the digital path to at least one digital sample according to step C). Specification of this keyword comprising code segment prior to searching the network may be done by manually assigning a keyword to said code segment. A predefined keyword (to be) incorporated in the keyword comprising code segment may be used as a search criterion for performing the sample search. Hence, there can be an overlap between the keyword comprising code segment and the one or more search criteria. An example of such an overlap when music samples have to be coded in a network environment by (manually) predefining the artist name, e.g. “Beatles”, which artist name can subsequently be used to as search criterion to filter music samples stored in said environment.

In a further embodiment of the method according to the invention at least one keyword comprising code segment is specified according to step D) subsequent to finding the digital path to at least one digital sample according to step C). The one or more keywords to be incorporated in the at least one keyword comprising code segment are preferably based upon the search results obtained, and more preferably based upon the digital path(s) found during the search. At least a part of a digital path leading to the digital sample may be incorporated as at least a part of at least one keyword comprising code segment. The sample code may be generated such that the digital path, or at least a part thereof, is incorporated in the sample code and can be recognized by a user.

The one or more search criteria used to conduct the searching operation can be various. In an embodiment at least one search criterion comprises a definition of folders (directories) to be searched. In this manner restricted parts of a network environment can be searched. It is moreover thinkable that at least one search criterion comprises a definition of sample types, in particular file types, to be searched. In this manner, for example, an extension filter can be applied, wherein solely files with a certain (predefined) extension, such as doc, docx, htm, html, ps, pdf, ppt, pptx, bmp, gif, jpg, jpeg, et cetera will be searched. It is also possible that at least one search criterion comprises a digital sample related date range to be searched. The date applied can e.g. be a date of creation of a digital sample, or a last date of opening of a digital sample. Other search criteria than the search criteria identified above may also be applied as well as combinations of search criteria.

Besides identifying the digital path where a digital sample is stored and the (file) name of the digital sample, also the content of the digital samples can be screened and searched. More in particular, in an embodiment of the method according to the invention during step C) the content of the at least one digital sample fulfilling the at least one search criterion defined is searched, and wherein at least one keyword, phrase, category, and/or user-defined code present in the digital sample found is used to specify at least one keyword comprising code segment during step D). It is thinkable to restrict the content to be searched, wherein the content may be restricted, for example, to searching the title, the header, the abstract, the body text, and/or the metadata of the digital sample. In a further embodiment, during step C) searching the content of at least one digital sample is followed by generating an index of keywords, phrases, categories, and/or user-defined codes found in the digital sample, and specifying at least one keyword comprising code segment based upon said index. A hierarchic order of keywords (or other items) may be applied which may be based on the number of hits (frequency). Specific predefined common keywords, phrases, categories, and/or user-defined codes may be disregarded by using an exclusion list. Preferably, excluded keywords (or other items) are disregarded during generation of the index of search results.

To reduce the number of different keywords, phrases, categories, and/or user-defined codes found in the digital sample, which shall become names of code template segments it could be advantageous to cluster multiple co-related keywords, phrases, categories, and/or user-defined codes in subsets, and by subsequently generating a cluster index of subsets is generated followed by specifying at least one keyword comprising code segment based upon said cluster index. For example, in case the keywords “seal*”, “weld*”, and “glue” are found during a search, these terms be clustered to a subset labelled by the cluster label “production”. The character “*” represents an asterisk as usual truncation of a keyword. This cluster term may be manually added after analysis of the search results though may also be performed automatically by known semantic analysis techniques, such as traditional techniques of taxonomy generation.

The sample code segments are selectively ordered to build an identifying path referring either directly or indirectly to a digital location, in particular a web location, where the digital sample can be found. The digital path will commonly be represented in the format of a (shortened) Uniform Resource Locator (URL) which may (automatically) be provided with a prefix, such as http, https, ftp, ftps, mailto, file, by a web browser. In an embodiment of the invention, at least a part of the digital path is identical to the sample code, meaning that the sample code is incorporated in the digital path. In case the sample code and the digital path are substantially identical, creating a cross-reference in accordance with step G) may be omitted. In this respect, the term “substantially identical” is being used to show that there may be a minor difference between the sample code and the digital path which do not have any effect in practice. For example, although the digital path will commonly have a prefix, such as “http://”, such a prefix may not be present in the visualized sample code itself. However, since any web browser will automatically add a prefix in front of a web address not already having such a prefix, the sample code as such may easily be used as web address (digital path) leading to a web location (digital location) where the requested digital sample is stored.

In an embodiment of the invention, the method includes step G) comprising storing the sample code, the digital path, and the cross-reference between the sample code and the digital path in a database. Storing the cross-reference as a link between the sample code and the digital path will facilitate translating the sample code into a digital path where the digital sample can be found. Moreover, storage of this data will facilitate updating the cross-references in case of a change of the digital path in order to prevent unlinking (dead linking) of the sample code with respect to the actual location where the digital sample is stored and can be traced and found.

The method optionally comprises step H) comprising converting the sample code generated during step C) into a machine-readable format. In case the sample code is printed or displayed on a screen, the sample code may be read, for example, by using an optical scanner. By applying optical character recognition, the scanned sample code will be converted into a set of characters identical to the sample string of the sample code, which can subsequently be entered either automatically or manually into a web browser. The machine-readable sample code may also be represented in a digital or physical encrypted iconographic format or technical, such as a 2D/3D barcode, a Uniform Resource Identifier (URI) such as a Uniform Resource Locator (URL), and/or a RFID tag. It should be noted that while these iconographic representations look similar to conventional iconographic and technical representations, the content, meaning, and use of the iconographic representation of the sample code is completely different from the conventional iconographic representation of known sample series and/or categories codes.

Alternatively, the method comprises step I) comprising translating at least the sample identifying code segment of the sample code into another language and matching characters or character sets. Since the sample identifying code segment preferably comprises metadata relating to the digital sample associated with the sample code, the metadata providing relevant recognizable information about the digital sample, it will be user-friendly to offer and display these metadata in the language and characters of the location/country where the digital sample code is issued. An example of possible metadata incorporated and named in the at least one sample identifying code segment is information relating to the author, title, subject, keywords, size, version, date of creation, remarks, and/or status of the digital sample.

The IP address and/or the domain name of an owner as incorporated in the owner identifying code segment is commonly not translated and commonly remains unchanged during step I).

In an embodiment of the invention the sample code segments defined during step A) further comprise a user related code segment which may either be static or dynamic (dependent on one or more parameters which change in course of time). Although each sample code, irrespective of the presence of a user related code segment, already functions as a world-wide unique personal code, one advantage provided by incorporating a user related code segment is that the content stored at the digital location can be made more personal to the user. If agreed upon, personal information of the customer such as a client number, pseudonym and/or personal permissions (e.g., read/write permissions), can be displayed as content at the digital location and/or as metadata incorporated in the user related code segment. This user information may be static which therefore results in a static user related code segment. It is also imaginable that the user related segment incorporates user related information (metadata) which varies with the course of time, such as the age of the user or the user credits. Once issued, the sample code will not change, but the sample code issued may be dependent on parameters which are applicable at the moment of issuing the sample code. In practice, this would commonly require a last-minute compilation of the sample code after registration of relevant user data, such as name, address, et cetera. It is conceivable that the user related code segment comprises a user identifying code segment. In this manner, the identity, such as the name of the user, is evident from metadata represented by the code segments.

It is further imaginable that the sample code string comprises at least one intermediary identifying code segment relating to the identity of an intermediary e.g., used to manufacture, supply, support, distribute, sell, and/or promote the sample. The intermediary identifying code segment, optionally based on the domain name or IP address of the intermediary, may comprise the identity of the intermediary but may also comprise other metadata relating to the intermediary, such as a platform or service offered to the public via which digital samples can be accessed. One example is related to the distribution of music files via a music publishing service, such as Apple's iTunes, in which music files may originate from the company EMI Music Publishing. A sample code associated with a specific digital sample may be represented as follows: “www.emi.com/www.itunes.com/beatles/yesterday-12345”, wherein “www.emi.com” represents the owner identifying code segment, “iTunes.com” represents the intermediary identifying segment, “beatles” the keyword (artist) comprising code segment, and “yesterday-12345” represents the digital sample identifying segment including metadata relating to the artist, the title, and a unique identification number of the digital sample. The sample code may also represent as web link to a location where the specific music file is stored, though the sample code may also be a cross-reference to another web link leading to the specific music file.

It may be beneficial during step A) to define at least one punctuation mark for separating adjacent code segments during step C). A variety of punctuation marks can be used, though since the sample code often functions as (shortened) URL, a slash (‘/’) sign may be used to separate adjacent code segments. In a correct (shortened) URL syntax commonly a slash sign is also positioned behind the last code segment. In addition to these separation characters, other typographic signs, such as a tilde (‘~’), a dot (‘.’), an underscore (‘ ’), and a minus sign (‘−’), may also be used within the code segments themselves and/or between the code segments.

In an embodiment of the invention, the sample code string comprises at least one checking code segment representing the result of a predetermined mathematical processing of at least one other sample code segment. The algorithm used to calculate the value of the checking code segment will be defined when defining the sample code structure during compilation of the sample code. This algorithm may for example use or have similarities with the known category coding system ISBN (International Standard Book Number) code check. The algorithm for generating an ISBN check characters works as follows. To generate the ISBN check character, each ISBN digit is multiplied by a predetermined associated weighting factor and the resulting products are added together. The weighting factors for the first nine digits begin with 10 and form the descending series 10, 9, 8 . . . 2. Thus for the nine digits 0 9 4 0 0 1 6 3 3, the products summed are 0+81+32+0+0+5+24+9+6=157. This sum is divided by the number 11. (157/11=14 with 3 remainder). The remainder, if any, is subtracted from 11 to get the check digit. (11−3=8). If the check digit is 10, it is represented by the Roman numeral X. The final ISBN in this example is accordingly 0-940016-33-8. By generating the check digit and comparing it with the received check digit, the validity of the ISBN may be verified. As mentioned above, a similar or comparable check may be incorporated in the sample code.

In another embodiment of the invention the sample code segments defined during step A) further comprises a sample code security identifying code segment. Application of this code segment will counteract abuse of the sample code by parties with malicious intent, since this security identifying code segment will be used as check to determine the authenticity of the sample code. For example, after entering the sample code into a web browser, a validity check of the sample code security identifying code segment may be performed. This security related code segment may be time-dependent (“dynamic”), meaning that the code segment will only be valid for a limited period of time. In case the security check shows that the sample code is no longer valid or in force, access to the digital sample will not be granted. The security identifying code segment hence acts as an interactive key to gain access to the digital sample file.

During step A) not only the number and kind of the code segments used to build a code may be defined, but also the order of defined code segments to be stringed may also be defined. This allows for creation of a complete sample code template (code format), which will be identified according tot the method and system as described in the aforementioned patent application PCT/NL2010/050303, and wherein code segments are ordered in a predetermined order. Determining the order of code segments during step A) can enhance the handling of sample codes and co-related storage locations of the digital samples.

In an embodiment of the invention, step A) may be repeatedly performed to generate multiple sample code templates, wherein the method further comprises step J) comprising choosing a code template to be applied prior to executing step B). Generating multiple templates may allow for additional differentiation in sample codes provided to users. For example, a party may offer digital samples directly to customers and indirectly to customers by making use of an intermediary. In doing so, different sample code templates may be used, where the direct customers may receive a code such as “www.owner.com/keyword/sample_id_{—}1234” which does not use an intermediary, while indirect customers may receive a code such as “www.owner.com/www.intermediary.com/keyword/sample_id_{—}5678” which utilizes an intermediary.

It is conceivable and commonly preferable that the sample code is embedded as metadata into the digital sample forming a tag, mark, or label of the digital sample, which facilitates tracking and tracing of the digital sample. The embedded sample code may be kept either visible or invisible (code inside the sample) for standard users. An embodiment of the invention comprises a digital sample that has a sample code according to any of the embodiments described herein.

An embodiment of the invention moreover relates to a computer-readable medium with computer-executable instructions which, when loaded onto a computer system, provide the computer system with the functionality of the method for compiling a sample code, and/or the method of providing a sample code to a digital sample as described above. Examples of computer-readable media are USB-sticks, internal and external hard drives, diskettes, CD-ROM's, DVD-ROM's, and others.

An embodiment of the invention additionally relates to a sample code as compiled by the above method. Advantages of the use of a world-wide unique sample code acting as a “fingerprint” have already been described herein.

An embodiment of the invention further relates to a system for compiling a world-wide unique sample code for an existing digital sample using the above method, comprising at least one sample code template generator for defining at least one sample code template comprising multiple sample code segments to be used for building a sample code for a digital sample, said sample code segments at least comprising a sample owner identifying code segment, a sample identifying code segment, and at least one keyword comprising code segment, at least one search criterion specification module for sample searching a digital networking, a digital network connected to said search criterion specification module for storage of digital samples, a search module connected to said digital network for finding a digital path to a storage location of at least one digital sample in the network fulfilling the at least one search criterion defined by means of the search criterion specification module, at least one sample code segment specification module connected to said template generator for specifying the content of the sample code segments defined by means of the code template generator and for generating a sample code for at least one digital sample found by the search module, wherein the sample owner identifying code segment is specified by an Internet address, in particular an IP address and/or a domain name, of an owner of the digital sample, and at least one database for storing at least one cross-reference between a generated sample code and the digital path to a digital location via which access can be gained to the digital sample in case the sample code and the digital path are mutually distinctive. For example, some embodiments of the sample code have already described herein. In an embodiment, the search module is configured to search at least a part of the content of at least one digital sample stored on the network and fulfilling the at least one search criterion defined by means of the search criterion specification module. In an embodiment of the system, the system further comprises a sample analysis module connected to the search module and the sample code specification module for analysis of the search results provided by the search module, wherein the analysis module may be is configured to hierarchically ordering and/or clustering the search results. Analysis and subsequent ordering of the search results can be very beneficiary to improve the efficacy for encoding existing digital samples with a unique sample code as already elucidated above comprehensively.

In some embodiments of the invention, the system may be a (cloud) computer-implemented system which may be fully automated after proper setup and initialization.

The system may further include at least one service module for administering the system for issuing a sample code. A digital user/administrator interface for controlling and maintaining the template generator, the specification module, and the code generator are included in the system according to an embodiment of the invention. The system may additionally include a sample storage device for storage of a digital sample at a digital location of which the digital path is stored in the database. An example of a suitable sample storage device is a web server, optionally in the cloud. In an embodiment of the invention, the system further includes a distribution/communication module for distributing/communicating the generated sample code to one of more users.

A code system employed in embodiments of the invention may not be context sensitive and may thus be applied in a wide range of different areas, including, but not limited to electronic samples, physical samples, services, and rights. (voor opmerkingen ad “mail carrier” zie Augmented reality betreffende “context independency and interoperability”) For example, mail carriers may use a package tracking system that allows for tracking of a package during its delivery. However, their tracking system only works in the context of their particular tracking environment, and cannot be used, for instance, to track items outside of that environment. Embodiments of the invention allow for a context-independent, broad or worldwide identification of specific samples based on metadata particular to each individual sample. If desired, the code system described in embodiments of the invention could be used in a specific internal scope by including an internal reference to the origin or scope of the sample inaccessible to outside users. In addition, a purely internal specification scope of the code system used by a specific company could be transformed into an external scope accessible to other organizations or individuals by integrating the origin or source of the sample into the specification scope. A scope change to transforming an external specification scope of the code system to an internal scope could also be similarly performed by removing a reference to the origin or scope of the sample. Furthermore, a code system according to an embodiment could be configured to allow for access to a variety of samples of different types. The other organizations or individuals may be provided access on a selected basis according to various embodiments, for example, with different levels of permissions, different groups and subgroups, different security levels, and so forth. Some embodiments of the invention pertain to the use of code generators for a variety of purposes, including, but not limited to the generation of values for a particular code segment, defining sample code templates used for building sample codes for a digital sample, or combining various sample code segments together to form a sample code. For example, a code generator may generate the specified segment values by executing its function using input values from a variety of data sources, including, but not limited to, queries on a database or metadata input from the digital sample. Code generators may be used for quality or integrity control segments, and also for segments with a dynamic value.

Some embodiments of the invention also allow for the controlled use of metadata solely on an authorization basis of the user. For example, code samples may include a segment identifying the ownership or source of the digital sample, which may be accompanied by user specification segments identifying the user of the code sample in more detail. For example, the user specification segment could consist of an intermediate such as a distributor or retailer, a customer, consumer, controller, customs, or could be use definitions such as a patient, practitioner, pharmacist, inhabitant, or other. Such a user segment could specify that special metadata concerning the sample could only be accessed by the authorized user of the sample code, requiring that user to authorize or grant specific access to that sample.

Some embodiments of the invention also allow for partial sharing of sample code segment values by several codes if the coded samples share a portion of their specification metadata for identification. This could enable the owner or user of the sample codes additional error-checking or verification options in determining if the code samples are valid, or could enable the owner or creator additional processing options based on the shared metadata.

Some embodiments of the invention allow for the combination of sample codes for several samples to identify a new sample based on an existing relationship between the combined samples. For example, the combination of the samples can preserve the origin of the samples as well as any specification criteria related to the intermediaries of the combined samples.

The following are drawings illustrating non-limiting embodiments of the invention, wherein:

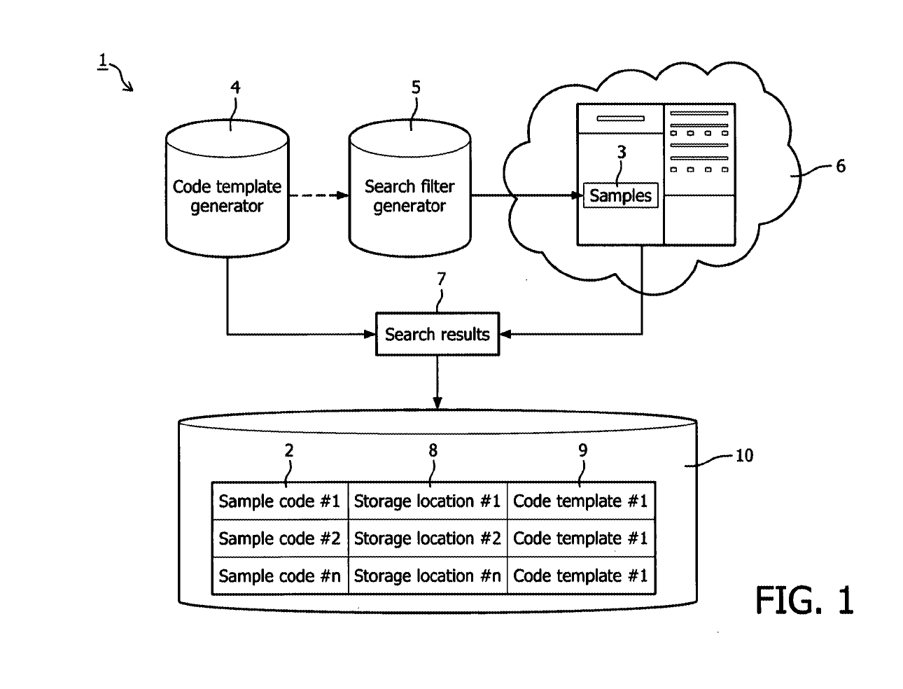

FIG. 1 shows a block diagram of a system for compiling a sample code for an existing digital sample according to an embodiment of the invention, and

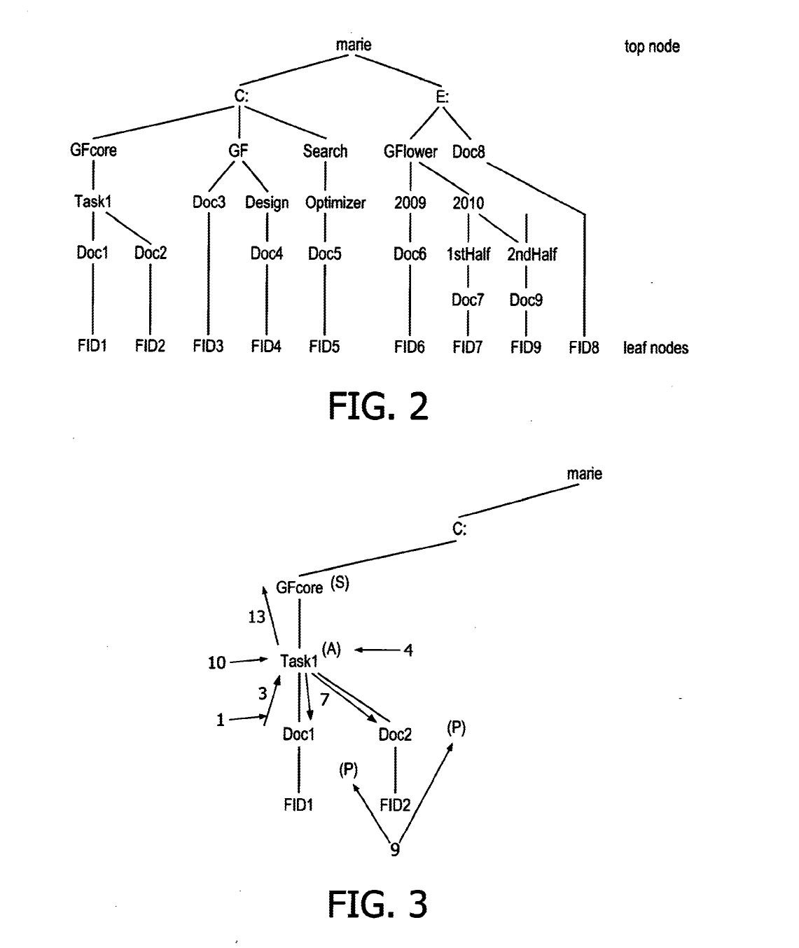

FIGS. 2-6 show schematic views of further embodiments of a method for compiling a sample code for a digital sample according to the invention.

FIG. 1 shows a block diagram of a system 1 for compiling a sample code 2 for an existing digital sample 3 according to an embodiment of the invention. To this end, the system 1 comprises a code template generator 4 for defining multiple sample code segments to be used for building a sample code 2 for a digital sample 3, said sample code segments at least comprising: a sample owner identifying code segment, a sample identifying code segment, and at least one keyword comprising code segment. The system 1 further comprises a search filter generator 5 by means of which one or more search criteria can be defined for sample searching an existing network environment 6 in which the digital samples 3 are stored. The network environment 6 may be a web based (cloud based) environment or may be a private network, such as an Intranet environment. The search criteria are used to filter samples 3 stored in said network environment 6 and to define which part of the network has to be searched and which part of the samples 3 has to be search. The part of the samples 3 to be searched may be the filename of the samples 3 and/or the content, such as title, body text, and/or abstract, of the samples 3. The search filter criteria may be based upon the code segments defined and eventually pre-specified by using the code template generator 4. By filtering the network environment 6 using the search filter criteria search results 7 will be obtained which may be processed, in particular analysed and/or further filtered. The search results 7 provide information about samples 3 fulfilling the search criteria as well as the storage location 8 of the samples 3. Based on the search results 7 and the code template defined by using the code template generator 4, different code segments will be specified and subsequently stringed to form one or multiple sample codes 2. The sample code 2 of a specific sample 3, the corresponding storage location (digital path) 8 of the sample 3, and the code template 9 applied are stored cross-referenced in a database 10. Embodiments of compiling a sample code 2 are described in the non-prepublished international patent application PCT/NL2010/050303, which document is incorporated herein by reference.

In the following further non-limitative embodiments of the method according to the invention are elaborated in textual and graphical manner, wherein three cases will be described:
1. First case: Code templates can be defined based on existing directory structures for storage of files;
2. Second case: Code templates are predefined. It has to be decided which existing files have to be encoded based on which of those templates; and
3. Third case: For the rest of the files or for all files, it is impossible to predefine code templates. The code templates have to be derived from the content and/or metadata of the file.

To support the encoding of existing documents according to the invention, the following preparations are made in all three described cases:
Files are located on their storage place, e.g. on several servers.
Metadata of the file are extracted as well as the access path to the file; the metadata of the file and the file is readable for the system of the invention.
A duplication recognition tool produces a list of duplicated files.
A person or a configurable condition decides which duplication exemplars of a file will be kept for the processing of the invention.
The rest of the duplications are deleted or kept in a special archive due to the desires of the corporation or person. Deletion is preferable due to an unambiguous situation. The next step ensures that no file will be lost.
The kept files for processing according to the invention are copied to keep an original for the case of data loss or whatever errors during processing. The copies will be deleted after encoding is finished and the encoded files are compared with the kept copies or stored original parameters before the processing started.

The processing is in principle automatic; however, preparation, some decisions during processing, and e.g. input of keywords in particular situations have to be made by knowledgeable users. These users act situation dependent; they have to record their decisions plus the reasons for their decisions.

In situations where known code templates are applied during the described processes, some segments of code templates are cut to remove the general part of the templates for processing. Before starting the particular procedure it is decided which segments of any applied code template will be considered for applying during the next steps of that procedure. Not considered segments will be e.g. the segments that define the transfer protocol, the domain server name of the legal owner, or a quality control segment. The considered segments are determined by the metadata or content of the files to be encoded. The not considered segments are determined by others, general specification criteria and are added already in parent code templates or will be calculated based on values that are generated in the next steps. The segment values remaining for value generation are called rest segments. For this cutting of more general segments, it can be imagined to use a question-answer tree to support the user who has to decide about the segments that shall be considered in the following processing. This way, knowledgeable, but technically less skilled users can decide about the input information for generating code templates. The answers should be selectable for each question to get useful user response. For the following described first case, a question could be: Which terms are the most generic ones to specify the files of your organization: Answer 1: GFCore, GF, Search, GFlower, and Answer 2: Task 1, Design, Optimizer, 2009, 2010. The content of the answer options is derived from the applied directory structure. For the following described second case, the offered answers to the same question as for the first case could be: Answer 1: the IP address of a legal owner, and Answer 2: project name.

Situations can be imagined where not all documents that have to be related to code templates and encoded following this template, are belonging to the same legal owner. In such a situation, a version of the second case can be applied to separate the files according to the several known legal owners by comparing metadata or part of the files with the set of keywords that contains the names of the legal owners. This is filtering the files with as filter criterion the names, IP-addresses etc. of legal owners; default list with names, IP-addresses, email addresses etc. can be used e.g. to avoid errors by manual insertion and being incomplete. In a situation where a legal owner is not known or not known partly, discovering the owner name is part of the analysis. In the following descriptions, it is supposed that the separation of files according to their owner is done. The description supposes that set by set of files is considered after each other; each set belonging to the same legal owner. The procedure has to be repeated for the next set of files with another legal owner than the already processed set of files.

### The First Case: Mapping Existing Pre-Coordinated Structure to Code Templates and Using it for Encoding File

The main idea of the first case is to use existing structural information to define the code templates for existing documents. The structural information covers the storage structure of the files, such as the names and sequence of the servers, drives, and folders (maps or directories) as well as the location of a file in a folder. In this case, it is supposed that existing structural information is based on some rationale on the meaning of the documents for the corporation or individual person. An in principle automated process is proposed with some manual processing and decisions in between made by knowledgeable users.

The files to be considered for encoding and deriving code templates from their existing storage structure are called revision files in the following description.

The start for deriving code templates is made by collecting some data about each revision file, e.g. the storage path of the file including the file's name and file format, the creator of the file, the size in k bytes from the metadata, the size on drive in k bytes, the creation date, and the revision number. Those data are being written into a database table; each file description in this database table gets a table internal record ID (here short: FID for file identifier). This ID is kept through the following processing to enable keeping the relationships between the derivation of the code templates and each of the particular files which belong to a particular derived code template. The result of this step is a database table with metadata on the files that shall be processed; containing among others the path to the storage location of each of the files as mentioned above. The FID values serve database internal referencing.

The next step after generating the content of the mentioned table with the file's metadata is to read the path attribute of each of the file record and split it in segments. A segment is equal to a node in the access/storage path of a file, e.g. the server name, a drive name, a directory name, and the file name. In an embodiment of the invention, the result can be imagined as a graph with the host/server name as an entry node and the drives and directories as nodes organized as graph branches. See the graph representation of FIG. 2 as an example. Within the graph, “marie” is the file server name. “C:” and “E:” are drives, the sequence GFcore, and Task1 is a branch leading to a document file with name Doc1 as well as to another document file named Doc2. Those nodes will be referred to as file-nodes in the following explanation. The file formats are not represented here because they are irreleveant for the processing as described according to the invention. “FID1” and “FID2” etc represent the internal table record ID's in the aforementioned database table.

A graph as shown in FIG. 2 is a suitable data structure to serve as intermediary between an existing storage structure of files and code template definitions in a database table, because both are applying the concept of parent-child data structure. The children refer to their parent as predecessor in the branch of directory tree, and a particular segment in a code template refers among others to its predecessor in the sequence of segments that are defining a code template. The data as represented in the example graph will be transformed into code templates and code templates create codes.

Before the presented graph is transformed into the data that represent the code templates, it is consider how to relate the necessary transfer step to the steps deriving a code template structure in general. The following explanation should help to understand the transfer steps that will be explained under Analysis steps.

In this embodiment, the general idea of the transformation analysis process is that during creating templates for documents, the last segment is used for defining the identification of the document itself; its name and file format with the separating dot as mentioned above. Branches that do not end in a file, but in an empty directory, are not considered any more in the next steps. It is assumed that those braches are not required as storage structures; thus, they do not have to be mapped into code templates.

Now, each branch of the graph leads to a file, e.g. a document. That is ensured already by the start of the transformation during creation of the above mentioned table containing the path for each revision file. The file is the last but one node of any branch of the graph, always. All file nodes that split from a common parent node belong to the same code template.

For saving analysis results, two database tables are used; called “Node” and DocNode” in the following description. Table Node defines each node value and its parent beside other data. Table DocNode defines the node value that represents the document file, its parent node identifier (=foreign key to the node record in table Node), the value of the leaf node (=the child node of the document file node=the ID of the file record table introduced at the beginning of the processing), and other utility data. A part of the table definitions is: Node(ID, ParentID, NodeValue) and DocNode(ID, NodeID, PathID, NodeValue).

Running through the graph bottom-up, saving the sequence of nodes and the node names, and keep the information which files have a common parent node, the code template definition is generated in principle. In an embodiment of the invention, this processing is supported by the following utility data: Each node of the graph has to have the option to carry a number of marks (S-mark for “start node”, P-mark for “processed”, A-mark for “anchor”). Using these additional marks, the steps to derive the code templates in the given embodiment of the invention are described in the following. Which node is carrying which mark during a particular process step, depends in the actual step and its sequence in the process flow. Notice, that only file-nodes can be P-marked. However, a file-node cannot carry an A-mark. A leaf-node (the FID's) cannot carry any mark at all.

Having explained the general idea of the analysis process, the analysis steps can be described. The description refers to the graph as shown in FIG. 2, to the two mentioned tables that save the analysis results, as well as to the three mentioned marks which can set for each node during processing.

Before running through the graph, mark all nodes that are selected as start nodes with the S-mark. The selection of the start node is derived from the preparation process as described in the general part above.

For the example graph as shown in FIG. 2, it is assumed here that the following nodes are S-marked: GFCore, GF, Search, GFlower, and Doc8. The result is an S-marked graph. Variables that are introduced to keep analysis results temporarily are marked by “<” and “>” before and after the variable's name.

Run through the graph branch by branch bottom-up:
1. Go to the first P-unmarked file node counting from left (at the beginning, there is no P-marked node at all; thus, the most left P-unmarked node is Doc1 at the start of the analysis-process); Result: found the first not yet processed file-node;
2. If this node is S-marked (see Doc8 in FIG. 2) create a record in DocNode with NodeID=NULL, NodeValue=name of the node, and PathID=content of child node of document node (=leaf node); mark the S-marked node also as P-marked and go to (1); otherwise continue with (3); Result: made decision if the found file node is also a start-node (S-marked);
3. Stop at the first parent node of the document node (Task1 in FIG. 2 in the first and second run of the analysis process); Result: found the parent of the file-node;
4. Set this node as anchor with anchor=index of node; Result: anchor set (is equivalent to “mark the actual considered node”;
5. Create a record in Node table for this anchor with NodeValue=name of node and ParentID=NULL; Result: kept the name of the actual node and its relation to the predecessor node; the latter is at this moment of processing still unknown; this is marked by the value “NULL”;
6. Keep the ID of the created anchor record as <child record ID>; Result: kept the database table ID of the actual node as variable;
7. Go one by one to its immediate children (for Task1 as anchor: Doc1 and Doc2); Result: found the children of the actual node;
8. If such a child is a file node (it has itself only one child, the FID), then create a record in table DocNode with as NodeID=ID of anchor node and PathID=content of the leaf node and NodeValue=name of node; Result: found a file; saving its name and parent as well as internal table record ID into the database;
9. Mark a processed file-node as P-marked; Result: node marked as processed.
10. After finished all children of the anchor, go to the anchor and set the anchor node index as <child node>; Result: anchor mark is removed.
11. If the anchor node is marked as start node: Repeat the procedure starting at (1) with the first unmarked document node from left. Otherwise continue with (12); Result: handled according to the S-mark of the last handled node: If the last processed anchor node is also a start-node, process the eventually existing next branches starting at this node; until now only file-nodes of the anchor node were considered. Repeat for all branches starting at the same node;
12. Go to its parent node; Result: found the parent of the former considered node;
13. Keep the node index of the parent node as <last visited node>; Result: kept the information of the last visited node for the process continuation;
14. Create a record in Node table for this last visited node with NodeValue=name of node and ParentID=NULL; Result: kept the information about the last visited node also in the database;
15. Keep the ID of the created record as <parent record ID>; Result: kept the database ID of the last entry to be used as reference from its children nodes in the database table; those references are still set to value “NULL”;
16. Update the ParentID of the record with Node.ID=<child record ID> with the <parent record ID>; Result: the now known parent reference is set in the database;
17. <child record ID>:=<parent record ID>; Result: preparation for the next step: the last considered database record ID will be the next <child record id> if the equivalent graph node has itself a parent node;
18. Repeat starting at (12) until a parent node is marked as start node (S-marked); the S-marked node is the last node that is processed as described between step 12 and 17. Do not consider the parent node of an S-marked node; Result: all branches of a start node (S-marked) are processed;
19. Repeat the procedure starting at (1) with the first P-unmarked document node from left; Result: found the next not yet processed branch; and
20. Stop if no not-processed file-node is left.

FIG. 3 shows a part of the example graph to illustrate some of the processing steps of the analysis steps. The figure shows the situation after two runs; the second run including step 9. The numbers are the process steps from the list above. The arrows illustrate the direction of the process. S, A, and P are the set marks. The left branch of the transformation graph of FIG. 2 with the marks from the substeps 1 until 19 of analysis step 2 of the transformation. The numbers in FIG. 3 thus refer to the aforementioned analysis steps.

After finishing the analysis for the whole graph, for example that one shown in FIG. 2, the tables Node and DocNode contain the records according to the graph example as shown. See Node table and DocNode table below.

TABLE NODE

| ID | ParentID | NodeValue |
|---|---|---|
| 1 | NULL | GFCore |
| 2 | 1 | Task1 |
| 3 | NULL | GF |
| 4 | NULL | GF |
| 5 | 4 | Design |
| 6 | NULL | Search |
| 7 | 6 | Optimizer |
| 8 | NULL | GFlower |
| 9 | 8 | 2009 |
| 10 | NULL | GFlower |
| 11 | 10 | 2010 |
| 12 | 11 | 1stHalf |
| 13 | NULL | GFlower |
| 14 | 13 | 2010 |
| 15 | 14 | 2ndHalf |

TABLE DOCNODE

| ID | NodeID | PathID | NodeValue |
|---|---|---|---|
| 1 | 2 | FID1 | Doc1 |
| 2 | 2 | FID2 | Doc2 |
| 3 | 3 | FID3 | Doc3 |
| 4 | 5 | FID4 | Doc4 |
| 5 | 7 | FID5 | Doc5 |
| 6 | 9 | FID6 | Doc6 |
| 7 | 12 | FID7 | Doc7 |
| 8 | 15 | FID9 | Doc9 |
| 9 | NULL | FID8 | Doc8 |

From tables Node and DocNode, code templates and codes can be created quite straightforward. From the Node table it is recognizable that a parent-child hierarchy has to be followed one by one; the node values have to be copied into the code segment table as well as the parent-children relationships; the segment values for the common template parts like legal owner and the transfer protocol have to be added as well as the last segment values for specifying the individual file identifier, e.g. called “document”. From the table DocNode, the values for the code creation are derived: the code template identifier is derivable via the attribute value NodeID, and the document name from attribute NodeValue. The value PathID enables to find the revision file unambiguous and copy it to the Part of file derived from the code template values. Additional, the file is tagged with the created code. These steps are not described here, because they are disclosed by the non-prepublished international patent application PCT/NL2010/050303. It is decided not to transfer the graph data of the above described database tables direct into the code template and code tables of the code engine database because both databases serve different purposes. The direct derivation into the database of the code engine would be possible from a technical point of view.

As examples, the derived code template of the left graph branch looks like http://www.greenflower.com/GFCore/Task1/document; the codes for the two documents of the left branch are http://www.greenflower.com/GFCore/Task1/Doc1 and http://www.greenflower.com/GFCore/Task1/Doc2.

### The Second Case: Using Existing Pre-Coordination Knowledge for Creating Code Templates and Encoding of Files

The main idea of the second case is to find the leaves code templates for an in general known code template hierarchy and to find which files belong to which of the leaves code template so that it can be encoded using this code template as blueprint. The second case covers also the situation that also the leaves code templates are known already and it has only to be discovered which files belong to which leaf code template. Both situations differ only in the first step, in general.

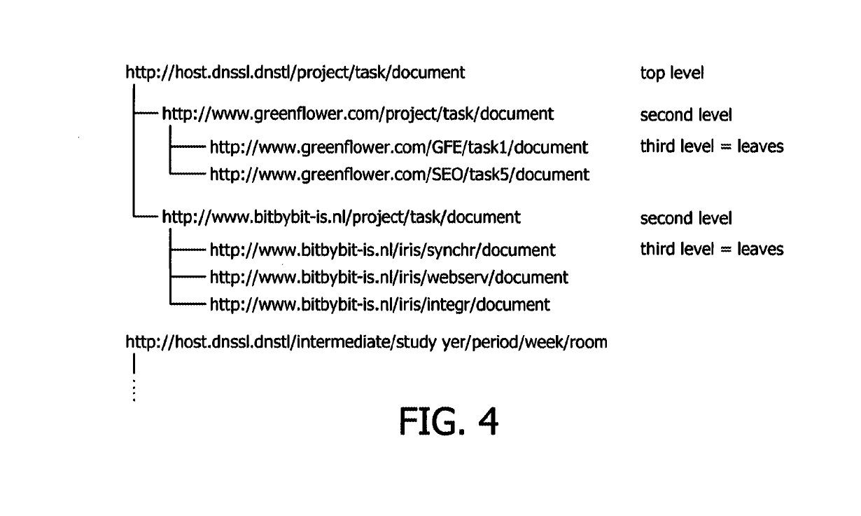

Consider the example of FIG. 4. Suppose the second level code templates are selected to structure the file library of the corporation. This is: http://www.greenflower.com/Project/Task/document.

As explained above, the general part of the applied code templates will be cut. Only the so-called rest segments will be considered for further processing. The first goal is to find the segment values for the leaves code templates for the segments called “Project” and “Task”. These are the segment values on the second level (in FIG. 4) that have only general description values and that are not aimed to identify the files itself. The second goal is to find all files which belong to each leaf template to enable encoding of the files. For the first goal, it is assumed that sets of keywords can be set up that contain the possible values for the children segments of the selected code template. For the example, a set of keywords would be established for the segment describing all projects and another set with keywords that describes tasks. It is supposed here, that knowledgeable users will insert the keywords related to each of the segments; e.g. for “Project”: Kernel, SEO, DB Design, Template generator, Code generator, Source generator etc.; and for “Task”: Concept, Functional design, Technical design, Discussion, Development, Test, Evaluation etc. Additionally, the user will indicate which keywords of “Task” belong to which keyword of “Project”. In general, a thesaurus, semantic network etcetera can be applied too. It could be that all named tasks are performed for each project; then, each keyword belonging to “Task” is related to each named project (each keyword for project). It could also be that only a subset of tasks is performed in each project. As a result, the mentioned example could form the following relationships among others:

| Project | Task by project |
|---|---|
| Kernel | Concept |
| Kernel | Functional design |
| Kernel | Technical design |
| Kernel | . . . |
| SEO | Concept |
| SEO | Functional design |
| SEO | Technical design |

From the above table, the desirable leaves code templates can be derived immediately.

### EXAMPLES

http://www.greenflower.com/Kernel/Cocept/document
http://www.greenflower.com/Kernel/FunctionalDesign/document
http://www.greenflower.com/Kernel/TechnicalDesign/document
. . .
http://www.greenflower.com/SEO/Concept/document
http://www.greenflower.com/SEO/FunctionalDesign/document
http://www.greenflower.com/SEO/TechnicalDesign/document
. . .

In the following text, the templates are referred to as T21, T22, etcetera if the part including segments for Project is meant, and T211, T212, T213, . . . T221, etcetera. if the part including segments for Task is meant.

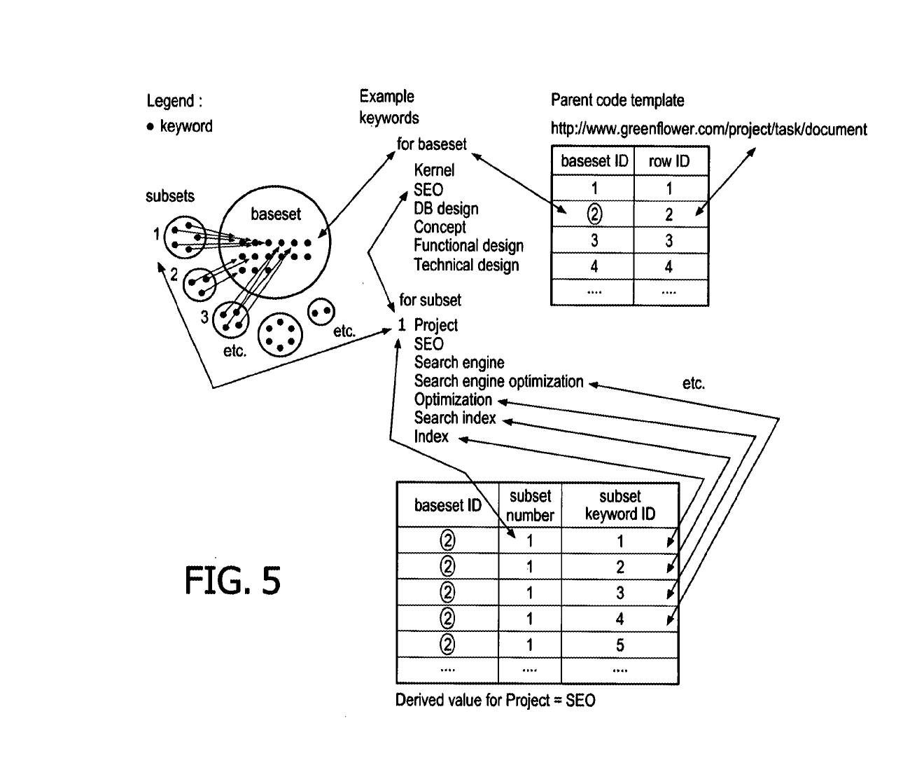

Given the situation, that the leaves code templates were known already, the first step here would be to derive the values of the aforementioned table from the given leaves code templates. This is straight forward reading the values of the rest segments and copying the values into the table with the structure shown in FIG. 5. The goal is to get the relationships between the rest segment values explicitly in a table for further analyzing. The above table is needed in both situations; the procedure to insert the values differs dependent on the fact if the leaves code template values are known at first, or if they have to be constructed from the values of the particular table.

For the second goal (finding the documents that shall be encoded with each of the constructed leaves code templates), it is assumed that at least the keywords, forming the segment values of the leaves templates are contained in the metadata of parts of the file content. If they occur there, it can be assumed that the file belongs to a code template that contains the keyword of one of its segment values. Moreover, the keywords from the segment value (forming the segment values) have not to occur itself in the metadata of the file content; it could be that a synonym or a semantic close neighbor of the keyword occurs in the file, meaning nevertheless that the file represents a content that is related to the keyword in a segment value of a template. E.g. if “SEO” is the keyword, an abbreviation, it can be that the file contains its long form “Search Engine Optimization” with upper- or with lower-cases characters, or it contains only parts of the long form like “search”, “search engine”, “optimization” or maybe even semantic close neighbors like “crawler”, and “indexing”.

To support finding the documents belonging to a particular code template, the expected keywords per template per segment have to be pre-defined as well as the keywords that are expected to occur as related to a particular keyword of the first established set. The first established sets of keywords are called base sets, here. The sets with keywords that are related to keywords in a base set are called subsets, here. It is supposed that a base set can contain keywords that belong to several code templates. Example: the base set of templates like in FIG. 4 and the above table, consisting of {Kernel, SEO, DB Design, . . . } belongs to all leaves code templates constructed from the table of FIG. 5 or being the source of the values of the above table (the leaves code templates were defined already before starting case 2). The subset {SEO, search engine optimization, internet search, search engine, optimization, crawler, index, . . . } refers to the base keyword “SEO” and the files containing some of the keywords of the related subset is supposed to belong to the code template with segment value for Project=SEO, in principle. This would be a beginning of the derivation of the conclusion, because it has to be evaluated if the rest of the segment values also have matches and if the matches for the project-segment have a good enough ranking considering the occurrence of the keyword within the document file in its whole and compared with the occurrence of the keyword in other document files from the same stock of crawled document files. A base set of keywords contains all keywords just once.

As aforementioned the set of code templates that is assumed as being suitable to serve as blueprint for coding existing files is listed. For each rest segment of each leaf code template on the list, a subset of keywords based on the base set is related to the segment via the base set. During this process, the base set could be extended by the knowledgeable users if a keyword is not contained for whatever reasons; the subsets will contain more keywords than keywords are in the base sets; this because the subsets contain those keywords that are expected to occur in the body or the metadata of the files that are related somehow to the code template where the considered segment belongs to. Each subset key or keyword gets a cross-reference with its key or keyword in the base set. Each keyword in a subset has to have a reference to a keyword in the base set. Each occurrence of a keyword in a file or its metadata is interpreted as a chance that the file belongs to a code template that contains the segment equivalent to the subset of the keywords. In general, a subset could contain keywords that refer to several base keywords. If there is no keyword in the base set that fits a keyword that is needed in a subset, the base set has to be extended with this keyword. A weight (factor) can be associated that is applied dependent on the file part of occurrence, e.g. the occurrence in the metadata gets a higher weight than the occurrence in a head line than the occurrence in an abstract then the occurrence in a paragraph etc. Associating weights is configurable. Other weight determining factors can be applied, also including relationships of keyword occurrences between each other. There is no principal reason to exclude any approach, in principle. It is also configurable which parts of a file should be crawled to find occurrences of the subset keywords.

A set of keys or keywords contains in any case the name of the code template segment and its known synonyms. It can contain also all the names and synonyms of the same segment of all the parent templates of the given template on the list. Additionally, it should contain keys or keywords that are conceptual related to the segment's name and synonyms based on the scope and purpose of the institution (semantic close neighbors). For each segment of each code template on the list as aforementioned, a cross-reference is made between the segment and the base set as well as between the base set and the subsets of keywords.

An illustration is given in FIG. 5. The keywords are symbolized by dots; the sets by circles. The relationships are represented by arrows between the sets and the applied tables. To illustrate the relationship between the base set ID in the two table, the ID is marked encircled. This is done to avoid another arrow crossing the rest of the figure.

The following part of the description illustrates the text above. It shows the steps realized to find the relationships between the leaves templates and files, e.g. document files. The process steps are illustrated by the mentioned example: Defining relationships between parent and leaves templates including segment relationships (table in short: Leaf segment table). The segment values are shown here for illustration; in fact the ID's would be applied. The following table is an extension of the previous table. In fact, both tables are the same in an embodiment of the invention.

Table: Defining relationships between parent
and leaves code template segments:

| | Top (parent) | Segment of | Leaf | |
|---|---|---|---|---|
| ID | template | parent | template | Segment of leaf |
| 1 | T1 | Project | T11 | Kernel |
| 2 | T1 | Project | T12 | SEO |
| 3 | T1 | Project | T13 | DB design |
| 4 | T1 | Task | T111 | Concept |
| 5 | T1 | Task | T112 | Functional design |
| 6 | T1 | Task | T113 | Technical design |
| 7 | T1 | Task | T121 | Concept |
| 8 | T1 | Task | T122 | Functional design |
| 9 | T1 | Task | T123 | Technical design |

Table: Defining the base sets of keywords:

| ID | Base set number | Base set keyword |
|---|---|---|
| 1 | 1 | Kernel |
| 2 | 1 | SEO |
| 3 | 1 | DB design |
| 4 | 2 | Concept |
| 5 | 2 | Functional design |
| 6 | 2 | Technical design |

Table: Defining relationships between the leaves segment
values and the base set keywords, wherein the Row ID is
the ID of the “Leaf segment table”, and the Base
set ID is the ID of table defining the base sets of keywords:

| Row ID | Base set ID |
|---|---|
| 1 | 1 |
| 2 | 2 |
| 3 | 3 |
| 4 | 4 |
| 5 | 5 |
| 6 | 6 |
| 7 | 4 |
| 8 | 5 |
| 9 | 6 |

Table: Defining the subset keywords:

| ID | Subset keyword |
|---|---|
| 1 | SEO |
| 2 | Search engine optimization |
| 3 | Internet search |
| 4 | Search engine |
| 5 | Optimization |
| 6 | Crawler |
| 7 | Index |
| 8 | . . . |

Table: Defining which subset keywords are belonging to which base
keyword; is equivalent to defining the subsets per base set (table
name short: BS-SS for base set - subset relationship):

| ID | Base set ID | Subset keyword ID | Subset number |
|---|---|---|---|
| 1 | 2 | 1 | 1 |
| 2 | 2 | 2 | 1 |
| 3 | 2 | 3 | 1 |
| 4 | 2 | 4 | 1 |
| 5 | 2 | 5 | 1 |
| 6 | 2 | 6 | 1 |
| 7 | 2 | 7 | 1 |
| . . . | . . . | . . . | |
| 765 | 5 | 27 | 12 |
| 766 | 5 | 45 | 17 |

Having finished this, file by file is crawled and compared for occurrences of keywords per subset. In an embodiment of the invention, a strategy is to start the comparison with the subsets that are related to any first or any last rest segment of code templates on the list. Afterwards, a ranking is done which of these subsets are the closest to the file; based on e.g. the weight of the keyword occurrences and frequency of occurrence.

Having finished this, the next comparison run is done only with the subsets on top of the first ranking list for the rest segments following (or preceding) the already compared segment. For illustration, assume that for a particular file, crawling segment 5 led to a high ranking of templates with a name started with T22. It seems not necessary to crawl subsets that are related to segment 6 of other templates like template T21 or T23 during analysis continuation.

How many entries on this first ranking list are considered for analysis continuation, is configured. E.g. if T21 and T22 would be ranked high for segment 5, the analysis will be continued with keyword subsets for both templates concerning segment number 6. Criteria for the configuration are e.g. a number of entries counted from the top or a number of entries that reach a particular ranking value. Having finished this, a second ranking list is calculated and the comparison is continued according to the ranking on the second list with the subsets of the third segments etc until the subsets of all rest segments are compared, limited by the ranking of the matches before. In general a keyword of a subset could be contained in several subsets related to several base sets, not only the occurrence in a subset has to be recorded, but also the relationship to the keywords from the segments from the parent template; here, e.g. to “Project” and “Task”, to conclude which subset number should be related to the keyword occurrence.

The next table shows an example for occurrences of keywords related to the subsets where they belong to. For illustration, the subset keywords are shown here; in fact the subset keyword ID would be applied. The table shows a part of the crawling results for a document file named “Doc1.doc”. All subsets are compared which relate to segments number 5 where segment nr 5 has the value “Project”.

| Subset keyword | Subset number | Part of file | Frequency |
|---|---|---|---|
| SEO | 1 | 1 | 1 |
| Kernel | 2 | 3 | 1 |
| Functional | 6 | 3 | 1 |
| SEO | 1 | 2 | 3 |
| Search engine | 1 | 3 | 4 |
| Start-up | 7 | 3 | 3 |
| Coding | 12 | 1 | 1 |
| Duplication | 13 | 1 | 1 |
| Index | 1 | 3 | 3 |
| Access | 14 | 4 | 1 |

In the example, “Part of file” indicates the level of the headlines. It is obvious that subset 1 has the most matches for the file where the above table content is derived from. The matches concern several headline levels. The other matched keywords are distributed over several subsets. It is supposed that the next comparison will happen with subsets that are referring to segments 6 of templates that referred from their 5^{th} segment to subset 1. In the example, this is the template shown in figure one; there could be more.

The comparison results are stored in a repository. From this repository, the final matching degree will be derived. The code template with the highest ranking for a compared file is cross-referenced and will serve as blueprint for encoding the file afterwards. The cross-reference stores the identification of the nearest code template, the identification of the file, and the matching degree.

The process is repeated after all files have been compared.

Depending on the configuration, files with a low matching degree or without any matching at all will be handled manually or handled according to the description of the third case or will be manually related to a code template if the third case doesn't lead to a result.

The files with a high enough matching degree will be encoded in accordance with the method according to the invention applying the cross-referenced code template.

| | Segment | | |
|---|---|---|---|
| File | number | Subset | Ranking |
| Doc1 | 5 | 1 | 1 |
| Doc1 | 5 | 7 | 3 |
| Doc1 | 6 | 12 | 2 |
| Doc1 | 6 | 8 | 1 |
| Doc2 | 5 | 1 | 1 |
| Doc2 | 5 | 14 | 4 |
| Doc2 | 6 | 4 | 1 |

The example shows that file Doc1 got a cross-reference for the first comparison step with subsets 1 and 7. Subset 1 belongs to code template T22 and got a ranking 1 (highest one); meaning it fits the keys very well. Subset 7 belongs to code template T91 and got a ranking of 3; meaning there were some correspondence between the keywords of subset 7 and file Doc1. The second comparison step produces two references, again, here to subset 12 of code template 112. The ranking is 2; meaning there is a good correspondence between some values of subset 12 and keywords found in file Doc1. The next reference is with subset 8 of template 221 and again with the highest ranking The match result is quite clear in this case. The most probable code template for encoding of file Doc1 will be T221.

The example shows that file Doc2 produced also two results during comparison step 1 (matches template T22), one with ranking 1 and the other with ranking 4. Ranking 4 is configured to be a reasonable high ranking; thus, the result was not cancelled out a step earlier. Altogether, also file Doc2 matches to code template T222 because the ranking of subset 4 for segment 6 is the 6^{th} segment of template T222. The value fits very well also with the ranking and value of T22.

The assumed codes will be:
For file Doc1.doc:
http://www.greenflower.com/SEO/Concept/Doc1.doc
   For file Doc2.docx:
http://www.greenflower.com/SEO/FunctionalDesign/Doc2.docx

The file extensions were skipped during the former explanation; they are part of the file name in fact.

The Third Case: Deriving Pre-Coordination Knowledge and Use it for Generating Code Templates and Encoding of Files

The main problem in the third case is to find a base set of keys or keywords, subsets of keys or keyword that could describe a file, and find an order between the keys or keywords within a particular subset to construct a code template out of the subset. Compared to the first case and the second case, there is no definition of a code template available. The only part of the templates that is known, concerns the legal owner segments, and eventually general segments were the value is a default value as aforementioned in the first case and second case already. In another embodiment of the invention, also the legal owner is not known and has to be derived from the file content or the files' metadata. The process is the same as deriving the other segment values, in principle. It is also assumed that a combination of the process described under the second case could be combined for these segments preferably. The combination between the second case and the third case could be advantageous for other segments, too; especially for segments with some assumed default values.

In an embodiment of the invention, a full text crawling of text documents is prevented. Text files will be crawled according to a configuration e.g. through the configured level of headlines. It is also configurable if an eventually existing abstract will be crawled (full text crawling in this part of a file). In any case, metadata are crawled. In another embodiment it is configurable that a full-text crawling of the body is done.

For other types of files e.g. only metadata and tags will be crawled. Before starting crawling, a list with keywords is filled which are excluded to be considered as keys or keywords; this list is called exclusion list.

| Part of file | Description | Evaluation | Weight |
|---|---|---|---|
| 0 | metadata | 1 | 5 |
| 1 | abstract | 0 | 4 |
| 2 | headline 1 | 1 | 4 |
| 3 | headline 2 | 1 | 3 |
| 4 | headline 3 | 1 | 3 |
| 5 | headline 4 | 1 | 2 |
| 6 | body | 0 | 1 |
| 7 | title | 1 | 3 |

Exclusion

the
is
he
she
etc. . . .

Then file by file is crawled through the configured parts. Each keyword that is not on the exclusion list is written down on a word-list together with a cross-reference to the part of file in the file. The part of file is not given explicitly; they are given as reference to the type of part of file like metadata, headline level 1, headline level 2, abstract etc. (see the aforementioned configurations). No further comparison is done during crawling.

| File | Keyword | Part of file |
|---|---|---|
| D | Production | 0 |
| D | Production | 2 |
| D | Production | 3 |
| D | Preparation | 3 |
| D | Preparation | 3 |
| D | Production | 4 |
| D | Production | 2 |
| D | Production | 2 |

After finishing this, the word-list is searched for duplications. The duplicated words are removed after counting the duplicates beside one occurrence as “keyword” per part of file and all affected references are reorganized to the one left over occurrence of each keyword per part of file plus the frequency per part of file. In another embodiment of the invention, the search to prevent duplication of keywords happens during building the word-list.

After finishing this, the list of keywords is ranked according to the ranking criteria like frequency of occurrence plus part of file of occurrence. No keyword is removed from the list even if it occurs at a low ranking

In an embodiment of the invention, synonyms will be reduced to a main keyword; this is a step with a result analog to the de-duplication mentioned above.

More reductions based on linguistic rules as well as semantics are imaginable. Intermediary table for ranking of a keyword within a file:

| File | | | |
|---|---|---|---|
| Keyword | Frequency | Part of file/WeigHt | Ranking |
| 1 | 1 | 0/5 | 5 |
| 1 | 3 | 2/4 | 12 |
| 1 | 1 | 3/3 | 3 |
| 1 | 1 | 4/3 | 3 |
| 2 | 2 | 3/3 | 6 |

A higher value for ranking is interpreted as a more important keyword concerning a file.

| ID | File | Keyword | Ranking |
|---|---|---|---|
| 1 | D | Production | 23 |
| 2 | D | Preparation | 6 |

The figure shows a straight forward overall ranking by building a sum of the local rankings Other ranking calculations are imaginable. The next step is to search trough the set of lists with the aim to find patterns of keywords for subsets of the lists. In an embodiment of the invention, data mining is applied to this step. Other approaches for pattern recognition can be applied; among others, such ones based on ontology. Applied methods can be derived also from ones suitable for determining importance in collaborative tagging systems and collaborative systems in general. The first step in pattern recognition, independent of the embodiment of applied methods and tools, is to find dominant index keywords or dominant set of keywords, respectively. As pattern is understood a subset of index keywords=keys or keywords where each keyword is prominent in forming the pattern. Non-prominent index terms get a relationship with the prominent keyword and will be represented by the prominent keyword in the continuation of the processing. Derived patterns have to be compared to find similar patterns or semantic close neighbors among the patterns as part of the first step. Aim is to reduce the number of quite similar patterns, if possible. Methods from analyzing collaborative systems can be applied for similarity calculation in an embodiment of the invention.

The next pattern recognition aims to find semantic relationships between the patterns of index terms, e.g. which are placed in the same branches (area) of a taxonomy. These next patterns are in fact meta-patterns in relationship to the first pattern recognition step; here, they are called clusters. This cluster building is possible due to the limited semantic areas that can be expected for documents, or in general files, of a corporation. It is known in general what the subjects of files are in a given corporate environment.

For example, it can be assumed in general, that files will contain data about projects, products, administration subjects, employees, contact etc. where a taxonomy or at least a semantic relationships between derived dominant keywords can be given as decision utility. The step of finding patterns can be repeated several times for refinement.

As longs as no criterion can be defined for deciding when to stop the refinement for pattern recognition, a person has to get involved for decision making. This is also the case for defining a stop-decision criterion for similarity of patterns.

As aforementioned, each pattern in a cluster is equivalent to a candidate subset of keys to define a segment of a code template. Each corresponding subset of similar or semantic close neighbors' pattern is supposed to belong to the same code template. The semantic range of keywords that will be included in forming a particular code template depends on the similarity criteria or close neighbor criteria respectively. The next step deals with defining a code template out of the candidate subsets of keys or keywords.

Nevertheless it is suitable to apply e.g. taxonomy to support this process; the first embodiment of the invention involves a person decision maker, at least partly. The patterns and derived dependencies between the keywords (based on e.g. taxonomy) will be presented to the person for decision. The relationship between the patterns and the files are kept to enable encoding of the files according to the code template that will be defined by the person based on a pattern. The “Keyword” column in the following table shows an example of prominent keywords found in the first step of pattern analysis. The “Subset” column shows a cluster of prominent keywords that are recognized as forming a set of semantic related keywords; here words describing production phases, tasks in production, and resource scheduling related words. In case of applying another taxonomy, other patterns could be found from the same pattern-sets. The values in the “Cluster” column are the result of the meta-pattern recognition.

| Cluster | Subset | Keyword |
|---|---|---|
| 1 | 1 | Production |
| 1 | 1 | Design |
| 1 | 1 | Sales |
| 1 | 2 | Preparation |
| 1 | 2 | Realization |
| 1 | 2 | Testing |
| 1 | 2 | Reporting |
| 2 | 1 | Building |
| 2 | 1 | Room |
| 2 | 2 | Lecturer |

From the above table it is assumed that each cluster will contribute to a particular code template. Furthermore, it is assumed that each subset of keywords related to a particular cluster will contribute to a code template segment. The first cluster is assumed to describe a code template for production phases. One of the segments will describe the production phase; the second one will describe work processes steps within a production phase. The code template hierarchy could be:
http://www.greenflower.com/production-phase/process/document
http://www.greenflower.com/design/preparation//document
http://www.greenflower.com/design/realization/document
http://www.greenflower.com/design/testing/document
http://www.greenflower.com/production/preparation/document etc.

The second cluster is assumed to describe building structures in the first subset and professions in the second one. Based on these two subsets of keywords, it is not sufficient evidence for concluding about the semantics of the code template; more data are necessary. If we would find an association with subsets describing times and activities it could be concluded that a code template for timetabling would be the right derivation.

In a further embodiment of the invention, the three cases are combined to cover the main situations in existing document storage organizations when all newly created files will be encoded in line with the method according to the invention and at least a part of the existing documents have to be included into the related new way of identifying, structuring, handling, and controlling files. Beside the encoding of existing files according to the three cases as exemplary embodiments of the invention, the transition into the new kind of working with files needs an organizational and administrational assistance to find a holistic solution for existing documents. The invention covers the technical aspects of encoding; beside this legal aspects have to be considered, e.g. if keeping of several copies at particular storage location is mandatory or if particular versions of files have to be kept etc. Administrational aspects have to consider also copies of existing files (now encoded) that are distributed to external receivers. Several situations have to be taken into account, e.g. if the external receivers just keep the received copy and never again will get a newer version of it or if they need new versions of the file etc. In case that they need new versions of the file, the external receivers have to get the codes of the files to enable accessing the newer versions, and they have to be asked to delete the former received copies in some situations. All these aspects will not be discussed here because they are administrational and business method aspects; however they are related to the invention.

In a further embodiment of the invention, the methods according to all three described cases will be coordinated to cover all situations imaginable in a n enterprise; furthermore, to extent the set of keys or keywords by indexing and pattern recognition with the aim to built up set of keys for encoding more files of the institution or even an application domain/field, service, research etc domain (application domain) set of default templates, based on a large amount of existing files in the field. Those set of keys can be refined by feedback from real application of subsets of keys or keywords in code templates and tendency of applicability of those code templates to files from a particular origin (a particular field, a subject, the creation date etc). This embodiment is considered to be a key generation method. The method of key generation can be refined in several ways such as integrating linguistic rules and approaches like applying synonyms, homonyms, or even syntax rules etc; however also translating the keys or keywords (multilingual key or keyword generation). Furthermore, a taxonomy of the application domain can be applied as well as self-learning algorithms e.g. based on the taxonomy, the generated set of keys or keywords and the feedback data from practical applicability of the subsets.

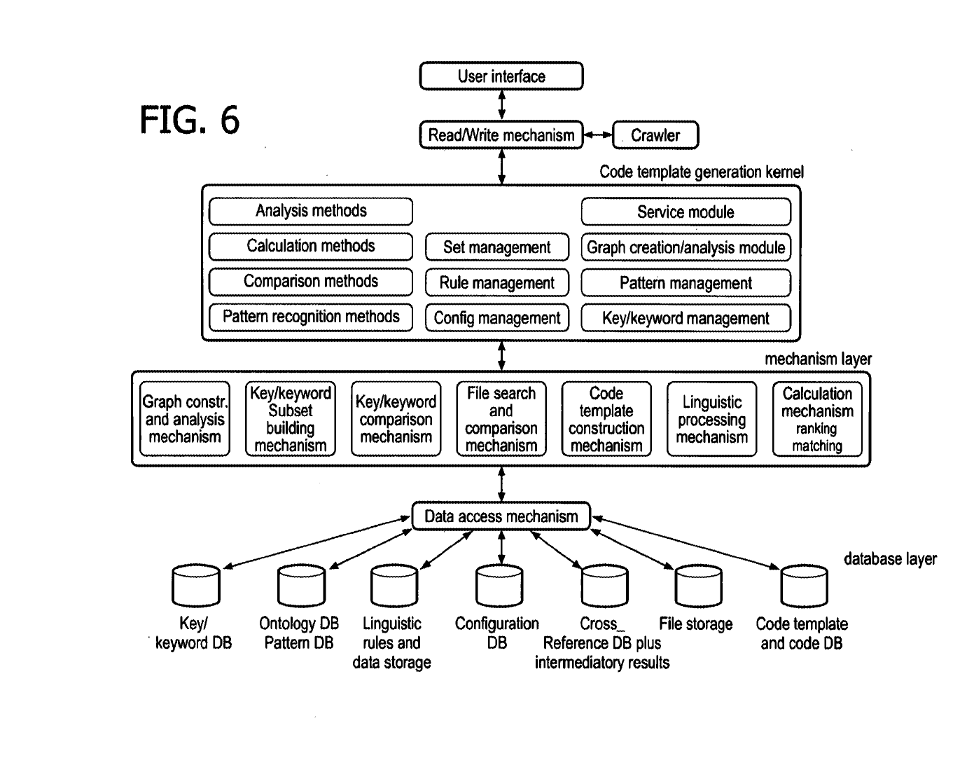

FIG. 6 shows the main building blocks of the system for compiling unique sample code templates for specific file content. At least the following databases are part of the system in an embodiment of the system according to the invention:
A key and keyword repository.
Taxonomy/ontology and a pattern repository.
A linguistic rule and data storage.
A configuration database.
A cross-reference database and a storage facility for intermediatory data including the graph representations and node data.
File storage.
A code template repository (the output results)

The databases are accessed via a data access mechanism. The next upper layer represents the building blocks from the business logic layer, at least:
Graph construction and analysis mechanism.
Key/keyword and Subset building mechanism.
Key/keyword comparison mechanism.
File search and comparison mechanism (crawling).
Code template construction mechanism.
Linguistic processing mechanism.
Calculation mechanisms for similarity, ranking and matching derivations.

The next upper layer represents the Code template generation kernel with at least the following building blocks:
Analysis methods including transformation graph analysis.
Calculation methods.
Comparison methods.
Pattern recognition methods.
Set management.
Rule management.
Graph creation and analysis management.
Pattern management.
Key/keyword management.
Configuration management.
Service handling, administration, and synchronization.

The upper part shows the building blocks enabling data in- and output, and finding and accessing the files where code templates have to be generated for encoding; at least:
User interface.
Crawler.
Read/write mechanism.

It should be noted that the above-mentioned embodiments illustrate rather than limit the invention, and that those skilled in the art will be able to design many alternative embodiments without departing from the scope of the appended claims. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be advantageously used.

1. A method for compiling a unique sample code for an existing digital sample, comprising:
A) defining at least one sample code template comprising multiple sample code segments to be used for building a sample code for a digital sample, said sample code segments at least comprising:
a sample owner identifying code segment,
a sample identifying code segment, and
at least one keyword comprising code segment,
B) specifying at least one search criterion for sample searching a digital network,
C) finding a digital path to a storage location of at least one digital sample in said digital network fulfilling said at least one search criterion,
D) specifying the content of the sample code segments to be used for building at least one sample code, wherein the sample owner identifying code segment is specified by an Internet address, in particular an IP address and/or a domain name, of an owner of the digital sample,
E) stringing the specified sample code segments to form the sample code, and
F) creating a cross-reference between the sample code generated during step E) and the digital path found during step C) in case the sample code and the digital path are mutually distinctive.

2. The method according to claim 1, wherein at least one sample code segment is specified according to step D) prior to finding the digital path to at least one digital sample according to step C).

3. The method according to claim 2, wherein at least one keyword comprising code segment is specified according to step D) prior to finding the digital path to at least one digital sample according to step C).

4. The method according to claim 3, wherein at least one search criterion defined during step B) is based upon a part of the keyword comprising code segment specified during step D).

5. The method according to claim 1, wherein at least one keyword comprising code segment is manually defined.

6. The method according to claim 1, wherein at least one keyword comprising code segment is specified according to step D) subsequent to finding the digital path to at least one digital sample according to step C).

7. The method according to claim 1, wherein at least one search criterion comprises a definition of folders to be searched.

8. The method according to claim 1, wherein at least one search criterion comprises a definition of sample types to be searched.

9. The method according to claim 1, wherein at least one search criterion comprises a digital sample related date range to be searched.

10. The method according to claim 1, wherein at least a part of the digital path, in particular at least one folder, found during step C) is used to specify at least one keyword comprising code segment during step D).

11. The method according to claim 1, wherein during step C) the content of the at least one digital sample fulfilling the at least one search criterion defined is searched, and wherein at least one keyword, phrase, category, and/or user-defined code present in the digital sample found is used to specify at least one keyword comprising code segment during step D).

12. The method according to claim 11, wherein during step C) searching the content of at least one digital sample is followed by generating an index of keywords, phrases, categories, and/or user-defined codes found in the digital sample, and specifying at least one keyword comprising code segment based upon said index.

13. The method according to claim 12, wherein a predefined exclusion list of keywords, phrases, categories, and/or user-defined codes is used prior to generating the index.

14. The method according to claim 12, wherein a multiple co-related keywords, phrases, categories, and/or user-defined codes found in the digital sample are clustered in at least one subset, and wherein a cluster index of subsets is generated followed by specifying at least one keyword comprising code segment based upon said cluster index.

15. The method according to claim 14, wherein a label is assigned to each subset, wherein the keyword comprising code segment is specified based upon the labels assigned to the subsets.

16. The method according to claim 1, wherein the digital path represents a Uniform Resource Locator (URL).

17. The method according to claim 1, wherein the digital path refers to a web location where the digital sample is stored.

18. The method according to claim 1, wherein the method comprises step G) comprising storing the sample code, the digital path, and the cross-reference between the sample code and the digital path in a database.

19. The method according to claim 1, wherein at least a part of the digital path and the sample code are identical.

20. The method according to claim 19, wherein the digital path and the sample code are at least substantially identical.

21. The method according to claim 18, wherein the method comprises step H) comprising converting the sample code formed in step E) into a machine-readable format.

22. The method according to claim 21, wherein the method comprises step I) comprising translating at least the sample identifying code segment of the sample code into another language and/or other character sets.

23. The method according to claim 1, wherein during step D) the sample identifying code segment is specified by identifiable metadata relating to the digital sample.

24. The method according to claim 1, wherein the sample code segments defined during step A) further comprises a checking code segment representing the result of a predetermined mathematical processing of at least one other sample code segment.

25. The method according to claim 1, wherein during step A) at least one punctuation mark is defined for separating adjacent code segments during step E).

26. The method according to claim 1, wherein during step A) an order of defined code segments to be stringed is defined.

27. A computer-readable medium with computer-executable instructions which, when loaded onto a computer system, provide the computer system with the functionality of the method as claimed in claim 1.

28. A sample code as compiled by the method according to claim 1.

29. A system for compiling a unique sample code for an existing digital sample, comprising:
at least one sample code template generator for defining at least one sample code template comprising multiple sample code segments to be used for building a sample code for a digital sample, said sample code segments at least comprising a sample owner identifying code segment, a sample identifying code segment, and at least one keyword comprising code segment,
at least one search criterion specification module for sample searching a digital networking,
a digital network connected to said search criterion specification module for storage of digital samples,
a search module connected to said digital network for finding a digital path to a storage location of at least one digital sample in the network fulfilling the at least one search criterion defined by means of the search criterion specification module,
at least one sample code segment specification module connected to said template generator for specifying the content of the sample code segments defined by means of the code template generator and for generating a sample code for at least one digital sample found by the search module, wherein the sample owner identifying code segment is specified by an Internet address, in particular an IP address and/or a domain name, of an owner of the digital sample, and
at least one database for storing at least one cross-reference between a generated sample code and the digital path to a digital location via which access can be gained to the digital sample in case the sample code and the digital path are mutually distinctive.

30. The system according to claim 29, wherein the search module is configured to search at least a part of the content of at least one digital sample stored on the network and fulfilling the at least one search criterion defined by means of the search criterion specification module.

31. The system according to claim 29, wherein the system further comprises a sample an analysis module connected to the search module and the sample code specification module for analysis of the search results provided by the search module.

32. The system according to claim 31, wherein the analysis module is configured to hierarchically ordering and/or clustering the search results.

33. The system according to claim 29, wherein the system further comprises a sample storage device for storage of a digital sample at a digital location of which the digital path is stored in the database.

34. The system according to claim 29, wherein the system further comprises a communication module for communicating the generated sample code to a user.
